(19) United States
(12) Patent Application Publication
(10) Pub. No.: US 2026/0307915 A1
(43) Pub. Date: Oct. 8, 2026

(54) SYSTEM FOR SELECTIVELY STOPPING PRODUCT FLOW IN A CONVEYOR

(71) Applicant: Laitram, L.L.C., Harahan, LA (US)

(72) Inventors: Joseph F. Kovacs, New Orleans, LA (US); John E. Wenzel, Madisonville, LA (US)

(21) Appl. No.: 19/485,063

(22) PCT Filed: May 7, 2024
(86) PCT No.: PCT/US2024/028152

§ 371 Date: Nov. 17, 2025

Related U.S. Application Data
(60) Provisional application No. 63/468,051, filed on May 22, 2023.

(51) Int. Cl. B65G 47/29; B65G 15/12; B65G 15/32; B65G 47/88

(52) U.S. Cl. CPC B65G 47/29; B65G 47/8807; B65G 15/12; B65G 15/32

(57) ABSTRACT

A conveying system employs a plurality of braking devices to selectively and temporarily stop product flow. A series of spaced-apart narrow belts extends longitudinally for conveying product from a first end to a second end. Selectively raisable brake pads are interspersed between the narrow belts. Actuators selectively raise a designated brake pad to push a selected product out of contact with one or more narrow belts to temporarily halt the forward movement of a selected product.

### RELATED APPLICATIONS

This application claims priority to U.S. Provisional Patent Application No. 63/468,051, filed May 22, 2023 and entitled “System for Selectively Stopping Product Flow in a Conveyor”, the contents of which are herein incorporated by reference.

### BACKGROUND OF THE INVENTION

The present invention relates to the field of power-driven conveyors. More particularly, the invention relates to a system and method for controlling the spacing of conveyed objects by selectively and temporarily halting a conveyed object.

It is often desirable to space conveyed objects in a selected manner along the travel direction of a conveyor, such as a conveyor belt. The spacing enables downstream processing, such as sorting by diverting of selected objects onto an exit conveyor. For example, it may be desirable to have only one parcel on a section of a conveying system, such as a diverter, at a time. Alternatively, it may be desirable for the parcels to have a uniform spacing, requiring automated equipment to set the parcels at a desired uniform gap.

### SUMMARY OF THE INVENTION

A conveyor includes a spacing section for spacing conveyed products. The spacing section comprises a series of spaced-apart narrow belts extending longitudinally and selectively raisable brake pads interspersed between the narrow belts, each having a width less than the width of the spacing section as a whole. Actuators selectively raise a designated brake pad to push a selected product out of contact with one or more narrow belts to temporarily halt the forward movement of a selected product.

According to one aspect, a conveyor comprises a conveyor bed extending longitudinally from a first end to a second end, a series of spaced-apart conveyor belts traveling over the conveyor bed from the first end to the second end and separated by channels and a plurality of brake pads disposed in the channels for selectively stopping a product being conveyed by one or more conveyor belts.

According to another aspect, a spacing section of a conveyor system comprises a first conveyor belt extending from a first end to a second end, a second conveyor belt extending from the first end to the second end and spaced from the first conveyor belt by a first longitudinally extending channel, a brake pad and an actuator. The brake pad has a first protrusion seated in the first longitudinally extending channel. The protrusion below the first and second conveyor belts in a first position. The actuator raises the brake pad so that the first protrusion extends above the first and second conveyor belts in a second position.

According to another aspect, a method of selectively stopping product flow in a conveyor comprises the steps of conveying a product in a longitudinal direction using a plurality of spaced-apart conveyor belts separated by one or more channels and selectively activating a brake pad in a channel to raise the product out of contact with the conveyor belts.

### BRIEF DESCRIPTION OF THE FIGURES

FIG. 1 is an isometric view of a spacing section of a conveyor system for selectively spacing products according to an embodiment;

FIG. 2 is a front view of the spacing section of FIG. 1;

FIG. 3 is an isometric view of a brake pad used in the spacing section of FIG. 1.

FIG. 4 is an isometric view of the spacing section of FIG. 1 with the series of conveyor belts removed;

FIG. 5 is an isometric view of the spacing section of FIG. 1 with the series of conveyor belts and wearstrips removed;

FIG. 6 is an isometric view showing the array of actuators used in the spacing section of FIG. 1;

FIG. 7 is a front, detailed view of a portion of the spacing section of FIG. 1, with an actuated brake pad stopping a conveyed product while another product continues forward conveyance;

FIG. 8 is a front view of an alternative embodiment of a brake device in an inactive position;

FIG. 9 shows the brake device of FIG. 8 in an active position.

### DETAILED DESCRIPTION OF THE INVENTION

A conveying system includes a spacing section comprising an array of product brake devices, such as brake pads, between narrow conveyor belts for selectively stopping a conveyed article. The present invention will be described below relative to certain illustrative embodiments. Those skilled in the art will appreciate that the present invention may be implemented in a number of different applications and embodiments and is not specifically limited in its application to the particular embodiments depicted.

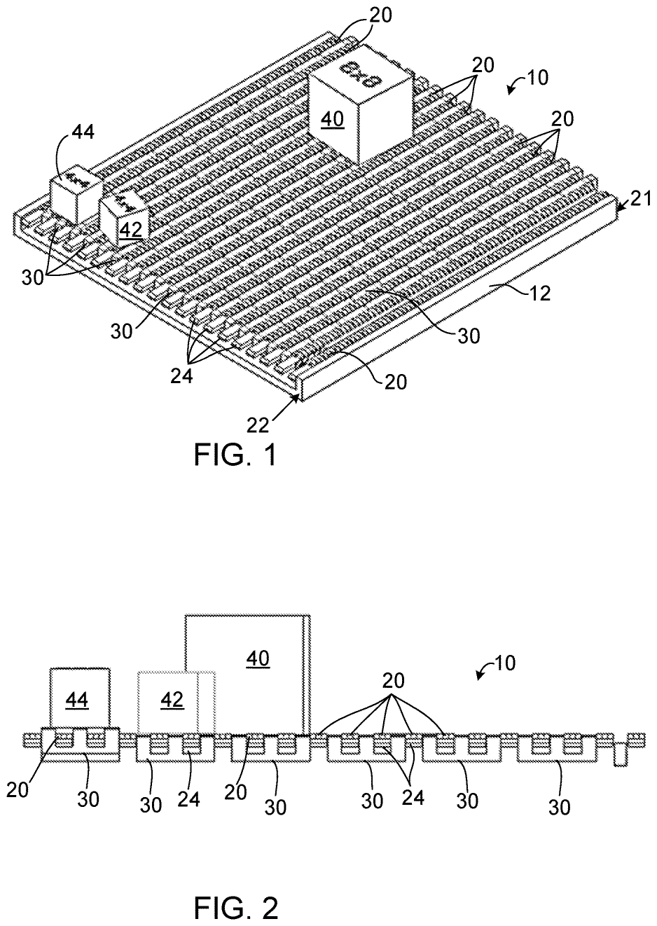

FIGS. 1-2 show a spacing section 10 of a conveying system including product brake devices, shown as brake pads 30, for selectively stopping the forward motion of a conveyed product. The spacing section 10 includes a plurality of spaced-apart, narrow conveyor belts 20 extending in a longitudinal direction from a first end 21 to a second end 22 over a frame 12. As used herein, “narrow” means that each conveyor belt has a width less than the width of the spacing section 10, so that the conveying means comprises a plurality of separate belts, rather than a single belt spanning the width of the spacing section. Each conveyor belt 20 rides on a wearstrip 24 extending in the longitudinal direction. Longitudinally-extending channels separate the conveyor belts. The conveyor belts 20 are separated by a selected distance, which can vary depending on the type of article conveyed. In the illustrative embodiment, the conveyor belts are separated by a separation distance approximately equal to the width of each conveyor belt, but the invention is not so limited. The illustrative conveyor belts 20 are narrower than the products being conveyed, so that a conveyed product is carried by multiple conveyor belts 20.

During normal operation, the conveyor belts 20 contact and convey product, shown as boxes 40, 42, 44, from the first end 21 to the second end 22. The spacing section 10 includes an array of a raisable brake pads 30 between the conveyor belts 20. The raisable brake pads 30 selectively lift a selected product 44 above and out of contact with the conveyor belts 20 to stop the selected product 44 while continuing to move other products 40, 42 in the forward longitudinal direction. After a selected period of time, a raised brake pad 30 can lower the lifted and stopped product back into contact with the conveyor belts 20 to continue conveyance. During normal operation, the brake pads 30 are below the conveyor belts 20 and out of contact with the conveyed products. The brake pads 30 can be raised and lowered in any suitable combination or order to control the flow of products.

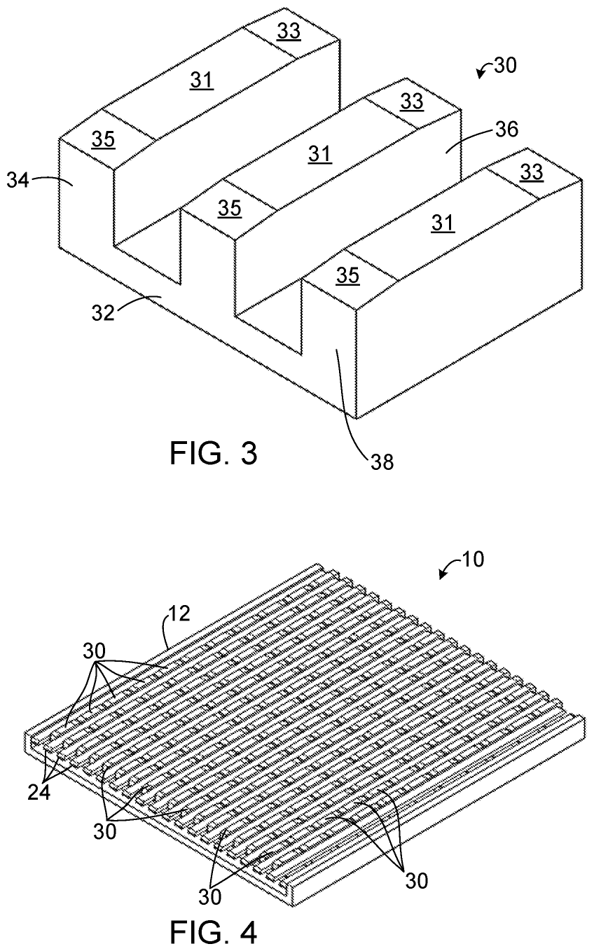

As shown in FIGS. 2 and 3, each illustrative brake pad 30 comprises a base portion 32 and a plurality of protrusions 34, 36, 38 extending up from the base portion. Each protrusion 34, 36, 38 fits into a channel between consecutive conveyor belts 20. Each protrusion 32, 36, 38 includes a flat top surface 31 between front and rear tapers, 33, 35 to facilitate the transition of the product between the conveyor belts 20 and brake pad 30. In an illustrative embodiment, each protrusion has a width about equal to the width of the conveyor belts 20 to optimize product contact, but the ratio of brake pad surface to conveyor belt surface can vary. The base portion 32 extends laterally below the wearstrips 24 and conveyor belts 20.

While the illustrative brake pad 30 includes three protrusions to span a plurality of conveyor belts 20, the invention is not so limited, and the brake pads 30 can be sized, shaped and configured in any suitable manner. Each brake pad 30 can be pushed upwards from below to selectively lift and stop a product for a selected amount of time before lowering the product back into contact with the conveyor belts 20 for further conveyance.

The brake pads 30 can be located in one or more selected regions or span the length and-or width of the conveying system. The illustrative spacing section 10 comprises a grid of individually actuatable brake pads spanning the length and width of the spacing section 10, but the invention is not so limited.

The illustrative conveyor belts 20 comprise hingedly connected plastic modules forming endless belts, but the invention is not so limited, and the conveyor belts 20 can alternatively comprise any suitable means for conveying products.

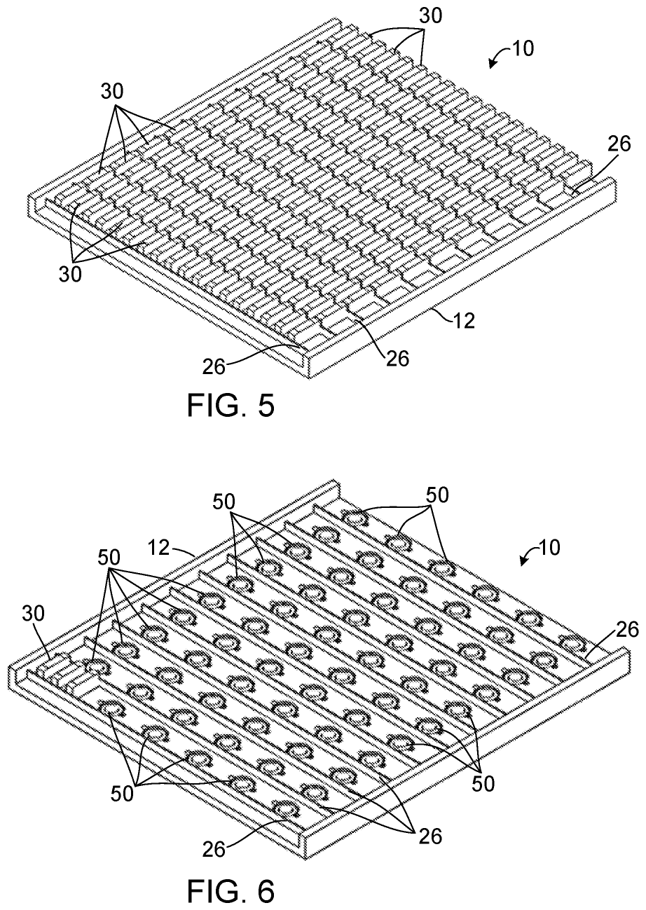

FIG. 4 shows the spacing section 10 of FIG. 1 with the conveyor belts 20 removed. As shown, the illustrative grid of brake pads 30 comprises a series of brake pads in each channel formed between the rows of wearstrips 24. FIG. 5 shows the spacing section with the conveyor belts 20 and wearstrips 24 removed to show the array of brake pads 30. As shown, the spacing section 10 includes support structure 26 for supporting and placing the wearstrips relative to the brake pads 30.

Referring to FIG. 6, the spacing section 10 further includes an array of actuators 50 for selectively activating the brake pads 30. The illustrative spacing section 10 includes a dedicated actuator 50 for each brake pad 30, but the invention is not so limited.

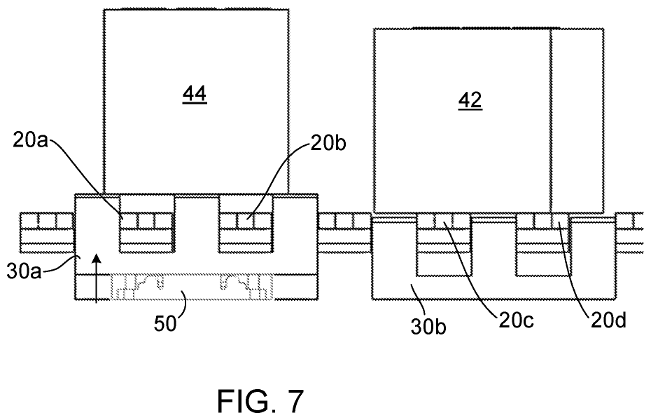

As shown in detail in FIG. 7, a selected brake pad 30a can raise and stop a product 44 by actuating the associated actuator 50 to push the brake pad 30a up, raising the product out of contact with the conveyor belts 20a, 20b that previously conveyed the product 44 to that location. Another product 42 on the spacing section 10 continues its forward movement, carried by conveyor belts 20c and 20d and out of contact with the lowered brake pad 30b.

When it is desirable to continue the forward movement of the stopped product 44, the actuator 50 lowers the brake pad 30a, bringing the product 44 into contact with the conveyor belts 20a, 20b, which then convey the product 44 forward.

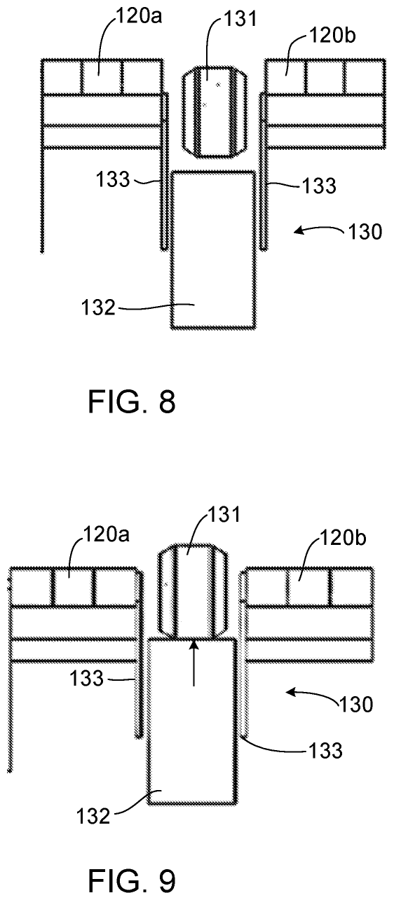

Referring to FIGS. 8 and 9, in another embodiment, a braking device 130 for a spacing section of a conveyor comprises a roller 131 in a channel between two conveyor belts 120a, 120b. The roller 131 or a series of rollers 131 are rotatably mounted to plates 133 abutting the conveyor belts 120a, 120b. During normal operation, as shown in FIG. 8, the roller 131 is below the conveyor belts 120a, 120b and out of contact with product conveyed by the conveyor belts 120a, 120b. To selectively brake a product, a free-spinning roller 131 picks up the selected product and raises it above the conveyor belts 120a, 120b, then a brake pad 132 below the roller rises into contact with the roller 131 to brake the roller, stopping the product, as shown in FIG. 9. The roller 131 can roll freely when not in contact with the brake pad 132. To release the product, the brake pad 132 is lowered out of contact with the roller 131, then the roller 131 is lowered to bring the product into contact with the conveyor belts 120a, 120b, which then convey the product forward. The roller creates gentler acceleration for the products to prevent tipping, tumbling, skewing and-or loss of orientation. The rollers reduce the amount of potential drag on non-standard products, such as polybags.

In another embodiment, the conveyor belts 20, 120 can be selectively lowered below braking devices to selectively stop product flow, then raised again to continue product conveyance.

The invention has been described relative to certain illustrative embodiments. Those skilled in the art will appreciate that the present invention may be implemented in a number of different applications and embodiments and is not specifically limited in its application to the particular embodiments depicted.

What is claimed is:

1. A conveyor, comprising:
a conveyor bed extending longitudinally from a first end to a second end;
a series of spaced-apart conveyor belts traveling over the conveyor bed from the first end to the second end and separated by channels; and
a plurality of brake pads disposed in the channels for selectively stopping a product being conveyed by one or more conveyor belts.

2. The conveyor of claim 1, further comprising a plurality of actuators for selectively raising the brake pads above the conveyor belts to raise a product out of contact with the conveyor belts.

3. The conveyor of claim 1, wherein each brake pad comprises a base portion that sits below the conveyor belts and a plurality of protrusions that extend up from the base portion into the channels.

4. The conveyor of claim 3, wherein each protrusion includes a flat top surface between front and rear tapering surfaces.

5. The conveyor of claim 1, wherein the conveyor belts comprise modular plastic conveyor belts.

6. The conveyor of claim 1, wherein each channel has a width about equal to a width of each conveyor belt.

7. The conveyor of claim 1, further comprising a roller above a brake pad.

8. The conveyor of claim 7, wherein the roller is rotatably mounted to plates abutting adjacent conveyor belts.

9. The conveyor of claim 1, wherein the brake pads form a grid extending from the first end to the second end and spanning the width of the conveyor bed.

10. A spacing section of a conveyor system, comprising:
a first conveyor belt extending from a first end to a second end;
a second conveyor belt extending from the first end to the second end and spaced from the first conveyor belt by a first longitudinally extending channel;
a brake pad having a first protrusion seated in the first longitudinally extending channel, the protrusion below the first and second conveyor belts in a first position; and
an actuator for raising the brake pad so that the first protrusion extends above the first and second conveyor belts in a second position.

11. The spacing section of claim 10, further comprising a third conveyor belt extending from the first end to the second end and spaced from the second conveyor belt by a second longitudinally extending channel.

12. The spacing section of claim 11, wherein the brake pad comprises a base extending below the second conveyor belt and a second protrusion seated in the second longitudinally extending channel.

13. The spacing section of claim 12, wherein each protrusion includes a flat top surface between front and rear tapering surfaces.

14. The spacing section of claim 12, wherein each protrusion has a width about equal to the width of the conveyor belts.

15. A method of selectively stopping product flow in a conveyor comprising the steps of:
conveying a product in a longitudinal direction using a plurality of spaced-apart conveyor belts separated by one or more channels; and
selectively activating a brake pad in a channel to raise the product out of contact with the conveyor belts.

16. The method of claim 15, further comprising the step of lowering the brake pad to place the product back into contact with the conveyor belts.

17. The method of claim 16, further comprising the step of activating a second brake pad in a second channel to raise a second product out of contact with the conveyor belts.

18. The method of claim 15, further comprising the step of conveying a second product in the longitudinal direction without activating a brake pad.
